(19) United States
(12) Patent Application Publication
(10) Pub. No.: US 2004/0211400 A1
(43) Pub. Date: Oct. 28, 2004

(54) Recycling circuit for crankcase gases of an internal combustion engine

(75) Inventor: Gillers Basset, Force (FR)

Correspondence Address: CROWELL & MORING LLP, INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/747,260

(22) Filed: Dec. 30, 2003

Related U.S. Application Data
(63) Continuation of application No. PCT/EP02/07265, filed on Jul. 2, 2002.

(30) Foreign Application Priority Data
Jul. 2, 2001 (FR) 01/08789

(51) Int. Cl. F02B 25/06

(52) U.S. Cl. 123/572

(57) ABSTRACT

A recycling circuit for crankcase gases from an internal combustion engine having an intake manifold with a throttling valve assembly and a cylinder head cover, in which a valve facilitates at least partial control of the flow of crankcase gases to be recirculated. The valve includes a spring and a diaphragm which divides the valve into two distinct chambers, one communicating with the atmosphere and the other communicating with the intake manifold, located downstream of the valve assembly, with a crankcase gas sampler, in which the chamber in communication with the manifold and with the crankcase gas sampler is integrated in the intake manifold and/or the cylinder head cover such that the membrane assures sealing of a part of the manifold or the cylinder head cover from the atmosphere.

### CROSS REFERENCE TO RELATED APPLICATIONS

This application is a continuation of international patent application no. PCT/EP02/07265, filed Jul. 2, 2002, designating the United States of America, and published in French as WO 03/004836 A1, the entire disclosure of which is incorporated herein by reference. Priority is claimed based on French Patent Application No. FR 01/08789, filed Jul. 2, 2001.

### BACKGROUND OF THE INVENTION

The present invention relates to a recycling circuit for crankcase gases on an internal combustion engine.

In internal combustion engines, the lack of seal between the combustion chamber and the crankcase results in the crankcase being progressively filled with blow-by gas or crankcase gas, which should be evacuated to prevent an increase in pressure. Formerly, these gases were exhausted directly into the atmosphere. However, an increasing concern for the environment has since led to the development of recycling circuits for these gases which reintroduce the gases into the engine for combustion.

Thus, in Engineering Technology (Volume BL2—Mechanical Engineering—Technology of Internal Combustion Reciprocating Engines—B 2800 by Christian Clos, 1996 Edition), the use of two recycling circuits is recommended: one primary circuit, which connects the crankcase gas tap to the air intake duct downstream of the throttle valve assembly, and which operates primarily at low speed when the throttle valve is (nearly) closed; and a secondary circuit, which connects the crankcase gas tap to the air filter, and which operates primarily at high speed when the throttle valve assembly is open. To avoid excessive vacuum in the crankcase, which would result in aspiration of oil, a vacuum limiter (diaphragm valve) can be placed in the primary circuit. However, this method involves a large number of parts and connections and its design is not optimized for a given engine.

European Patent Application No. EP 724,206 discloses an improved circuit comprising a diaphragm valve provided with an outlet that can be connected to the crankcase gas tap and another outlet that can be mounted directly on the intake manifold. Such a circuit always involves attaching a separate part on the manifold during assembly of the vehicle, with the risks of leaks resulting therefrom. Moreover, it is relatively heavy and expensive and is not optimized for a given engine, the valve being a standard valve with a broad operating range.

### SUMMARY OF THE INVENTION

It is therefore an object of the invention to provide an improved recycling circuit for crankcase gases from an internal combustion engine.

Another object of the invention is to provide a crankcase gas recycling circuit which minimizes the number of parts to be assembled when the engine is being built.

A further object of the invention is to provide a crankcase gas recycling circuit which minimizes the risk of leaks.

An additional object is to provide a crankcase gas recycling circuit having a design which is easy to optimize in accordance with a given engine.

These and other objects are achieved in accordance with the present invention by providing a recycling circuit for crankcase gases of an internal combustion engine equipped with an intake manifold provided with a throttle valve assembly and a cylinder head or rocker cover, said recycling circuit including a crankcase gas recirculation valve for at least partially regulating a recycling flow of crankcase gases, said recirculation valve comprising a spring and a diaphragm or membrane that divides the recirculation valve into two distinct chambers, one of said chambers communicating with the atmosphere and the other of said chambers communicating with the intake manifold downstream of the throttle valve and with a crankcase gas tap, wherein the chamber communicating with the manifold and with the crankcase gas tap is integral with the intake manifold or the cylinder head cover or both, and wherein the diaphragm seals part of the manifold or the cylinder head cover or both relative to the atmosphere.

Accordingly, the present invention concerns a recycling circuit for crankcase gases on an internal combustion engine equipped with an intake manifold provided with a throttle valve assembly and a cylinder head cover, in which a valve makes it possible at least partially to regulate the recycling flow of crankcase gases, said valve comprising a spring and a diaphragm that divides the valve into two distinct chambers, one communicating with the atmosphere and the other with the intake manifold downstream of the throttle valve and with a crankcase gas tap, characterized in that the chamber communicating with the manifold and with the crankcase gas tap is integral with the intake manifold and/or the cylinder head cover, and in that the diaphragm makes it possible to ensure the seal of part of the manifold and/or the cylinder head cover to the atmosphere.

As used herein, the term “internal combustion engine” is understood to refer to an electric-ignition engine comprising at least one cylinder in which a piston slides, driven in a reciprocating movement that is transformed into a rotary movement by means of a crank and connecting rod system, and in which the chemical energy of combustion of a fuel is transformed into kinetic energy of rotation of a shaft.

The present invention applies to any type of internal combustion engine, but preferably to an engine for a motor vehicle, and in particular to a gasoline engine for an automobile that includes an intake manifold provided with a throttle valve assembly for regulating the supply of combustion air to the cylinder of the engine. Moreover, these engines are equipped with a crankcase that contains lubricating oil, and a cylinder head cover that covers the cylinder head of the engine (where the oil is injected) and which ensures the seal as well as the thermal and sound insulation to the outside. The crankcase and the cylinder head cover generally communicate with each other and constitute a system in which the crankcase gases circulate.

According to the invention, these gases are tapped in the crankcase/cylinder head system by means of a tap generally placed at its upper part.

The valve that regulates the recycling flow of crankcase gases according to the invention is a diaphragm valve, that is, it comprises a diaphragm and a spring the relative movement of which produces either the opening or the blocking of communication between the crankcase gas tap and the manifold. The diaphragm divides the valve into two chambers: one communicating with the atmosphere, and the other communicating with the intake manifold and the crankcase gas tap. According to the invention, the diaphragm is also used to provide the seal of one part of the manifold and/or the cylinder head cover relative to the atmosphere, and in so doing allows an economy of material (the wall of the manifold and/or cylinder head cover being interrupted at that place).

The present invention advantageously allows the secondary recycling circuit to be eliminated by means of proper determination of size, which will be detailed below. In this case, the entirety of the recycling flow is regulated by the valve described above.

### BRIEF DESCRIPTION OF THE DRAWINGS

The invention will be described in further detail hereinafter with reference to illustrative preferred embodiments shown in the accompanying drawing figures, in which:

FIG. 1 is a schematic representation of a first illustrative embodiment of a crankcase gas recirculation valve according to the invention, and

FIG. 2 is a schematic representation of another illustrative embodiment of a crankcase gas recirculation valve according to the invention.

### DESCRIPTION OF PREFERRED EMBODIMENTS

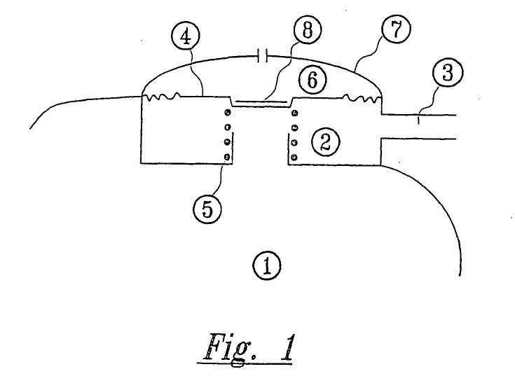

According to a first variation of the present invention, illustrated in a non-limiting way in FIG. 1, the manifold (1) and the cylinder head cover (not shown) are separate parts and the valve is integral with the manifold. In this case, the chamber (2) communicating with the manifold (1) and the crankcase gas tap (not shown) through a connecting tube (3) is integral with the intake manifold, the diaphragm (4) serving both to ensure the seal of the manifold and to regulate the recycling flow, along with the spring (5). Indeed, there is a constant equilibrium between the force exerted by the atmospheric pressure on one side of the diaphragm (chamber 6) and the forces exerted on the other side (chamber 2) by the vacuum in the crankcase, by the vacuum in the manifold and by the spring.

The sizing of the elements of this valve (usable diameter of the diaphragm, displacement of the diaphragm [function of its rigidity], diameter of the communication orifices, hardness of the spring, etc.) is optimized for a given engine in order to allow its direct integration into the intake manifold. Such optimization (on engine bench, for example) makes it possible to reduce significantly the size of the diaphragm and to ensure good regulation for all points of operation of the engine.

With respect to the gain in material and number of parts, it will be noted that the system according to this variation of the invention is reduced to the essentials: it essentially comprises a diaphragm/spring pair, a housing (7), a connection to the crankcase gas tap (3), and means (such as clamps) of attaching this connection to the valve and to the tap (which are not shown), respectively. The housing (7) can be attached in any appropriate way to the manifold, such as by clip-on or welding.

Advantageously, in order to prevent wear of the diaphragm as well as to optimize the dimensions thereof, the diaphragm can include a reinforcement (8) at its center, where it comes into contact with the orifice to the manifold (9), this orifice generally being the end of a tube. The reinforcement can be an insert, preferably of a material that is more rigid than the diaphragm.

According to a second variation of the present invention, the manifold and the cylinder head cover are also separate parts, but this time the valve is integral with the cylinder head cover. In this case, the volume (1) of FIG. 1 is the volume situated between the cylinder head and the cylinder head cover, and the connection (3) this time connects the valve to the manifold, everything else being equivalent to the first variation described.

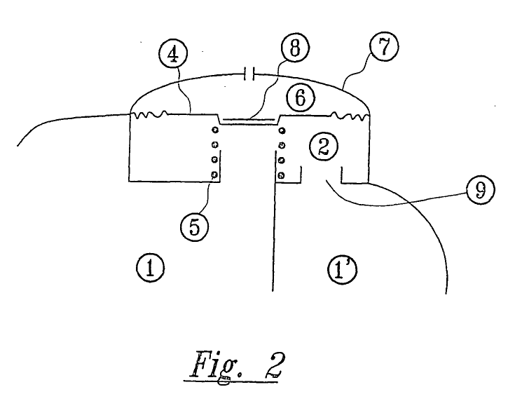

According to a third, preferred variation of the present invention, the intake manifold and the cylinder head cover are integral with each other, that is, they have at least one common wall. This variation, illustrated in a non-limiting way in FIG. 2, enables the number of parts to be reduced even more compared to the other variations, because it makes it possible to eliminate either the connection to the crankcase gas tap (variation 1) or to the manifold (variation 2) as well as the means of attaching this connection. Indeed, the valve is simply positioned astride the manifold and the cylinder head cover, and the crankcase gases beneath the cylinder head cover are directly tapped via an orifice (10) in the lower part of the housing (7) situated beneath the cylinder head cover.

In FIG. 2, (1) represents the internal volume of the intake manifold and (1′) represents the volume between the cylinder head and the cylinder head cover. This fully integrated system (manifold, cylinder head cover, and recycling circuit) has only one element to be attached during assembly of the vehicle, and because it is optimized for each type of engine, it enables a maximum reduction of the exhaust to the atmosphere while reducing the weight and size of the parts.

The materials that comprise the elements of the system according to the invention are selected according to their weight, their mechanical strength and their workability, depending on their function and design. Thus, in particular to reduce the weight of the unit and to facilitate its production, it can prove to be advantageous to select plastic parts as much as possible, i.e., for the majority of the parts, perhaps with the exception of the spring and the clamps. For example, the diaphragm and the connection to the tap are preferably elastomer based (such as a silicon rubber, fluoro-silicon, or modified acrylic [ACM]), and preferably of a fluorinated elastomer if the environment requires it; the clamps and the spring are often made of a metal that is resistant to the environment under the hood and to salt spray; and the housing of the valve is advantageously of a thermoplastic material such as a polyamide or a polyolefin, but preferably a polyamide. This plastic material is preferably reinforced with a filler such as glass fibers. The housing is generally produced by molding, injection molding being particularly suitable.

The present invention also concerns an integrated intake manifold for internal combustion engine, said manifold including the valve of the system according to the first variation of the invention.

The present invention also concerns an integrated cylinder head cover for internal combustion engine, said cylinder head cover including the valve of the system according to the second variation of the invention.

The present invention also concerns an integrated intake manifold/cylinder head cover for internal combustion engine, said manifold/cylinder head cover including the valve of the system according to the third variation of the invention.

The present invention also concerns a method for designing a crankcase gas recycling circuit of an internal combustion engine as described previously. This method consists of optimizing the parameters (geometry, materials, etc.) of the previously described valve based on the parameters of operation of an engine, through the use of an engine bench. Engine bench is understood to designate a test bench which, based on the characteristic points of the engine (function of speed and torque), makes it possible to assign a recycling flow of crankcase gas and a vacuum at the intake. The value of the vacuum is then measured at the crankcase and that value is compared to the one in the vehicle manufacturer's specifications.

Finally, the present invention concerns a diaphragm valve for a recycling circuit, an integrated intake manifold and/or cylinder head cover as described above, this valve preferably being made of plastic material; “principally made of plastic material” is understood to mean the housing of the valve is of plastic material, preferably moldable by injection (such as a polyamide or a polyolefin, optionally with glass fiber filler), and the diaphragm is also of plastic material, preferably a elastomer. Optionally the elastomer may be a silicone-coated elastomer or a fluorinated elastomer.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A recycling circuit for crankcase gases of an internal combustion engine equipped with an intake manifold provided with a throttle valve assembly and a cylinder head cover, said recycling circuit including a crankcase gas recirculation valve for at least partially regulating a recycling flow of crankcase gases, said recirculation valve comprising a spring and a diaphragm that divides the recirculation valve into two distinct chambers, one of said chambers communicating with the atmosphere and the other of said chambers communicating with the intake manifold downstream of the throttle valve and with a crankcase gas tap, wherein the chamber communicating with the manifold and with the crankcase gas tap is integral with the intake manifold or the cylinder head cover or both, and wherein the diaphragm seals part of the manifold or the cylinder head cover or both relative to the atmosphere.

2. A recycling circuit according to claim 1, wherein said recirculation valve regulates the entire recycling flow of crankcase gases.

3. A recycling circuit according to claim 1, wherein the manifold and the cylinder head cover are separate parts, and the recirculation valve is integral with the manifold.

4. A recycling circuit according to claim 1, wherein the manifold and the cylinder head cover are separate parts, and the recirculation valve is integral with the cylinder head cover.

5. A recycling circuit according to claim 1, wherein the intake manifold and the cylinder head cover have at least one common wall, and the recirculation valve is positioned astride the manifold and the cylinder head cover in order to enable direct tapping of crankcase gases under the cylinder head cover.

6. An intake manifold for internal combustion engine, wherein said intake manifold integrally comprises a crankcase gas recirculation valve according to claim 1.
